(19) United States
(12) Patent Application Publication
(10) Pub. No.: US 2023/0384028 A1
(43) Pub. Date: Nov. 30, 2023

(54) AIR NOZZLE AND COATER

(71) Applicant: JIANGSU CONTEMPORARY AMPEREX TECHNOLOGY LIMITED, Changzhou (CN)

(72) Inventors: Fang Luo, Changzhou (CN); Huan Che, Changzhou (CN); Wei Chen, Changzhou (CN); Shisong Li, Changzhou (CN)

(21) Appl. No.: 18/447,330

(22) Filed: Aug. 10, 2023

Related U.S. Application Data
(63) Continuation of application No. PCT/CN2022/091387, filed on May 7, 2022.

(30) Foreign Application Priority Data
Nov. 5, 2021 (CN) 202122699031.9

(51) Int. Cl. F26B 3/28; F26B 3/30; F26B 21/00

(52) U.S. Cl. CPC F26B 3/283; F26B 3/30; F26B 21/004

(57) ABSTRACT

Provided are an air nozzle and a coater. The air nozzle includes an air outlet chamber, an air return chamber, and an infrared light assembly, where the air outlet chamber includes an air outlet panel, the air outlet panel facing a substrate to be treated; the air return chamber is provided with an air return panel on a side facing the substrate, the air return panel being provided with a plurality of punch holes for communication with the air return chamber; the air outlet panel is configured to convey a medium inside the air outlet chamber to outside the air nozzle, and the medium enters the air return chamber through the air return panel after passing through the substrate; and the infrared light assembly is provided on a path of the medium entering the air return chamber.

### CROSS-REFERENCE TO RELATED APPLICATIONS

This application is a continuation of International Application PCT/CN2022/091387, filed May 7, 2022, which claims priority to Chinese patent application No. 202122699031.9, filed on Nov. 5, 2021 and entitled “AIR NOZZLE AND COATER”, which are incorporated herein by reference in their entireties.

### TECHNICAL FIELD

This application relates to the field of coating device technologies, and in particular, to an air nozzle and a coater.

### BACKGROUND

In general, a coater is mainly used for a coating process on surfaces of substrates. The main working process is to coat the slurry on the surface of the substrate and make it dry before winding up. Drying is generally implemented using a multi-section drying box. The drying box is equipped with an air nozzle for blowing air to the surface of the substrate to accelerate the drying. However, using only air nozzles for drying has limited drying efficiency. At present, an infrared drying system is added in the drying box to promote heating of the substrate surface through infrared irradiation, so as to accelerate the drying procedure. Such method has gradually become the mainstream in the field of coater technology. The key component of the infrared drying system is an infrared light. After drying is completed, the infrared light needs to be cooled to prevent the infrared light from long being in a high temperature state and affecting the coating efficiency. For this purpose, an emitter cooler is mostly used to cool the infrared light in some cases.

However, in the actual application, because the light temperature can reach 750° C. or above when the infrared light is fully opened, using only the emitter cooler for cooling has a low cooling efficiency, and the substrate is easily discolored and broken during the cooling process, resulting in lower utilization of the substrate. Moreover, after addition of the infrared drying system, a matching emitter cooler needs to be added, greatly increasing installation costs. Therefore, there is an urgent need for an air nozzle and a coater.

### SUMMARY

Embodiments of this application provide an air nozzle and a coater, to facilitate rapid cooling of outer surfaces of an infrared light in the coater.

According to a first aspect of the embodiments of this application, an air nozzle is provided, including an air outlet chamber, an air return chamber, and an infrared light assembly, where the air outlet chamber includes an air outlet panel, the air outlet panel facing a substrate to be treated; the air return chamber is provided with an air return panel on a surface facing the substrate, the air return panel being provided with a plurality of punch holes for communication with the air return chamber; the air outlet panel is configured to convey a medium in the air outlet chamber to outside the air nozzle, and the medium enters the air return chamber through the air return panel after passing through the substrate; and the infrared light assembly is provided on a path of the medium entering the air return chamber.

With the above structure, a mounting position of the infrared light assembly is set on a path of a first medium entering the air return panel, allowing the medium used in large amount for drying to be effectively utilized. When the medium passes through the infrared light assembly, a large amount of heat is removed from the infrared light assembly through conduction heat dissipation and convection heat dissipation. This not only implements rapid cooling of the infrared light assembly, but also implements secondary utilization of the medium to effectively replace the use of an emitter cooler, significantly cutting the installation costs for using an infrared drying system.

In some embodiments, the air outlet chamber and the air return chamber are spaced apart in a first direction.

With the above structure, the air outlet chamber and the air return chamber being spaced apart can effectively integrate the space occupied by the air outlet chamber and the air return chamber, optimizing the internal structure of the air nozzle.

In some embodiments, the air outlet panel is formed by two opposite air outlet side panels that are bent to respective opposite sides, where a gap is present between the two air outlet side panels, and the air return panel is provided within the gap.

In some embodiments, the air return panel is provided with a sink groove sunk in a second direction, the infrared light assembly is provided on a bottom wall of the sink groove, and punch holes are provided in the bottom wall of the sink groove.

In some embodiments, the bottom wall of the sink groove faces the substrate.

With the above structure, such arrangement of the air outlet side panels allows the air outlet chamber and the air return chamber to be spaced apart. Moreover, the arrangement of the sink groove makes the infrared light assembly be mounted at an end of the path of the medium entering the air return chamber, effectively fitting the air return path of the medium. In addition, the air return volume at this place is huge, facilitating cooling of the infrared light assembly.

In some embodiments, the air outlet panel is provided at one end of the air nozzle, the air return panel is provided around the air outlet panel, and the infrared light assembly is provided on the air return panel.

With the above structure, the air return panel being provided on one side of the air nozzle allows the air outlet chamber and the air return chamber to be spaced apart.

In some embodiments, the air return panel is provided with a side groove sunk in the first direction, punch holes are provided in a bottom wall of the side groove, and the infrared light assembly is provided on an opening of the side groove, close to one side of the air outlet panel.

With the above structure, the infrared light assembly is provided on the opening of the side groove, close to one side of the air outlet panel, so that the medium needs to pass through the infrared light assembly after entering the air return chamber path, thus effectively extending a contact time between the medium and the infrared light assembly and improving the cooling effect of the medium on the infrared light assembly. The above structure also allows the infrared light assembly to be provided on the outside of the air nozzle, separate from the air nozzle, which reduces obstruction that blocks the infrared light assembly from irradiating the substrate, thus improving an irradiation effect of the infrared light assembly.

In some embodiments, the air outlet chamber and the air return chamber are spaced apart in the first direction.

With the above structure, the air outlet chamber and the air return chamber being spaced apart can prevent the media in the air outlet chamber and the air return chamber from affecting each other due to close proximity of the two chambers.

In some embodiments, a mounting groove sunk in the second direction is formed on a side of the air return chamber close to the air outlet chamber, a bottom wall of the mounting groove facing the substrate, the infrared light assembly is provided on the bottom wall of the mounting groove, and the air return panel is provided in the mounting groove, on a side away from the air outlet chamber.

With the above structure, arrangement of the mounting groove makes the medium enter the air return chamber path and passes through the infrared light assembly, ensuring the cooling effect of the medium on the infrared light assembly. Moreover, the arrangement of the mounting groove also reduces obstruction that blocks the infrared light assembly from irradiating the substrate, thus improving the irradiation effect of the infrared light assembly.

According to a second aspect of the embodiments of this application, a coater is provided, including the foregoing air nozzle, where an air drying duct in the coater communicates with the air outlet chamber on the air nozzle, and an air return duct in the coater communicates with the air return chamber on the air nozzle.

Compared with the related art, in the air nozzle of the embodiments of this application, the mounting position of the infrared light assembly is set on the path of the first medium entering the air return panel, allowing the medium used in large amount for drying to be effectively utilized. When the medium passes through the infrared light assembly, a large amount of heat is removed from the infrared light assembly through conduction heat dissipation and convection heat dissipation. This not only implements rapid cooling of the infrared light assembly, but also implements secondary utilization of the medium to effectively replace the use of an emitter cooler, significantly cutting the installation costs for using an infrared drying system.

### BRIEF DESCRIPTION OF DRAWINGS

To describe the technical solutions in the embodiments of this application more clearly, the following briefly describes the accompanying drawings required for describing the embodiments of this application. Apparently, the accompanying drawings in the following description show merely some embodiments of this application, and a person of ordinary skills in the art may still derive other drawings from the accompanying drawings without creative efforts.

FIG. 1 is a schematic structural diagram of an embodiment of an air nozzle according to this application.

FIG. 2 is a schematic structural diagram of an internal structure according to the embodiment shown in FIG. 1.

FIG. 3 is a schematic structural diagram of an air outlet panel according to the embodiment shown in FIG. 1.

FIG. 4 is a schematic structural diagram of another embodiment of an air nozzle according to this application.

FIG. 5 is a schematic structural diagram of still another embodiment of an air nozzle according to this application.

In the accompanying drawings: 1. air outlet chamber; 11. air outlet panel; 111. air outlet side panel; 2. air return chamber; 21. air return panel; 22. punch hole; 201. sink groove; 202. side groove; 203. mounting groove; 3. infrared light assembly; 4. mounting strip.

### DESCRIPTION OF EMBODIMENTS

The following describes in detail the embodiments of technical solutions in this application with reference to the accompanying drawings. The following embodiments are merely used to describe technical solutions in this application more explicitly, and therefore they are merely used as examples and do not constitute a limitation to the protection scope of this application.

Unless otherwise defined, all technical and scientific terms used herein shall have the same meanings as commonly understood by those skilled in the art to which this application belongs. The terms used herein are merely intended to describe the specific embodiments but not intended to constitute any limitation on this application. The terms “include”, “comprise”, and “having” and any other variations thereof in the specification, the claims and the foregoing brief description of drawings of this application are intended to cover a non-exclusive inclusion.

In descriptions of embodiments of this application, the terms “first”, “second” and the like are merely intended to distinguish between different objects, and shall not be understood as any indication or implication of relative importance or any implicit indication of the number, specific sequence or primary-secondary relationship of the technical features indicated. In the descriptions of this application, “a plurality of” means at least two unless otherwise specifically stated.

In this specification, reference to “embodiment” means that specific features, structures or characteristics described with reference to the embodiment may be incorporated in at least one embodiment of this application. The word “embodiment” appearing in various places in the specification does not necessarily refer to the same embodiment or an independent or alternative embodiment that is exclusive of other embodiments. Persons skilled in the art explicitly and implicitly understand that the embodiments described herein may combine with another embodiment.

In the descriptions of embodiments of this application, the term “and/or” in this application describes only an association relationship for describing associated objects and represents that three relationships may exist. For example, A and/or B may represent the following three cases: A alone, both A and B, and B alone. In addition, a character “I” in this specification generally indicates an “or” relationship between contextually associated objects.

In the description of the embodiments of this application, the term “a plurality of” means more than two (inclusive). Similarly, “a plurality of groups” means more than two (inclusive) groups, and “a plurality of pieces” means more than two (inclusive) pieces.

In the description of the embodiments of this application, the orientations or positional relationships indicated by the technical terms “center”, “longitudinal”, “transverse”, “length”, “width”, “thickness”, “upper”, “lower”, “front”, “rear”, “left”, “right”, “perpendicular”, “horizontal”, “top”, “bottom”, “inside”, “outside”, “clockwise”, “counterclockwise”, “axial”, “radial”, “circumferential”, and the like are based on the orientations or positional relationships as shown in the accompanying drawings. These terms are merely for ease and brevity of description of the embodiments of this application rather than indicating or implying that the apparatuses or components mentioned must have specific orientations or must be constructed or manipulated according to specific orientations, and therefore shall not be construed as any limitations on embodiments of this application.

In the description of the embodiments of this application, unless otherwise specified and defined explicitly, the terms “mount”, “connect”, “join”, and “fasten” should be understood in their general senses. For example, they may refer to a fixed connection, a detachable connection, or an integral connection, may refer to a mechanical connection or electrical connection, and may refer to a direct connection, an indirect connection via an intermediate medium, or an interaction between two elements. Persons of ordinary skill in the art can understand specific meanings of these terms in this application as appropriate to specific situations.

At present, from market development prospects and application trends, a coater needs to be used in the production process of many cutting-edge items. In general, the coater is mainly used for a coating process on surfaces of substrates. The main working process of the coater is to apply and dry the slurry on surfaces of substrates before winding up. Drying is generally implemented using a multi-section drying box. The drying box is equipped with an air nozzle for blowing air to the surface of the substrate to accelerate the drying. However, using only air nozzles for drying has limited drying efficiency. At present, an infrared drying system is added in the drying box to promote heating of the substrate surface through infrared irradiation, so as to accelerate the drying procedure. Such method has gradually become the mainstream in the field of coater technology. The key component of the infrared drying system is an infrared light. After drying is completed, the infrared light needs to be cooled to prevent the infrared light from long being in a high temperature state and affecting the coating efficiency. For this purpose, an emitter cooler is mostly used to cool the infrared light in the prior art.

The inventors of this application have noted that the emitter cooler equipped for the infrared light in the existing coater has major defects in a practical application process. In the actual application, because the light temperature can reach 750° C. or above when the infrared light is fully opened, using only the emitter cooler for cooling has a low cooling efficiency, and the substrate is easily discolored and broken during the cooling process, resulting in lower utilization of the substrate. Moreover, after addition of the infrared drying system, a matching emitter cooler needs to be added. This not only leads to more structures inside the coater, higher energy consumption of the coater and sharply increased installation costs, but also requires time- and effort-consuming re-adjustment of the architecture inside the coater.

In order to alleviate defects of the infrared light used in the existing coater, the applicant has found that the infrared light and the drying structure of the air nozzle can be combined and adjusted so as to cool the infrared light through air return in the drying structure of the air nozzle. Such method can promote effective use of resources inside the device to reduce production waste, and reduce modifications to an internal structure of the existing coater, and is widely applicable to the existing coaters.

Based on the above considerations, in order to resolve the problem of the infrared light used in the existing coater, the inventors of this application have designed an air nozzle and a coater through in-depth study.

The foregoing coater can be a brush coater, an air knife coater, a scraper coater, a roller coater, a spray coater, a curtain coater, a slit coater, and the like used for the coating process on surfaces of films, paper, and the like. The embodiments of this application impose no special limitation on the foregoing coater.

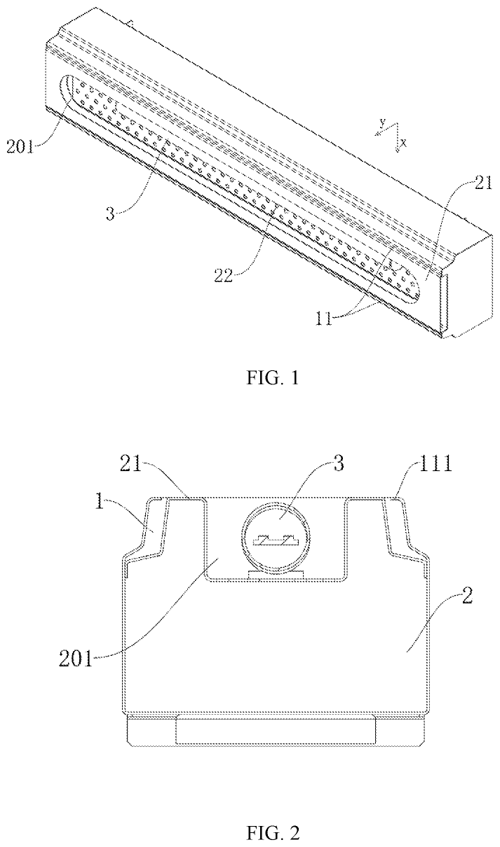

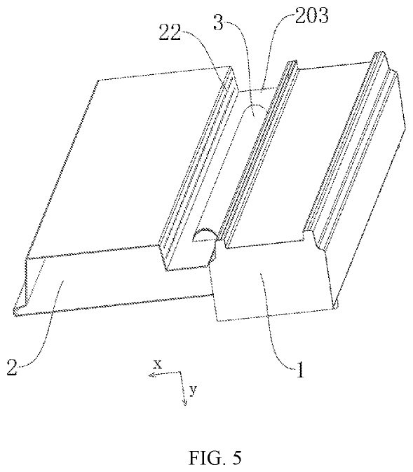

Referring to FIG. 1, FIG. 4, and FIG. 5, in the embodiments of this application, the first direction is an x-axis direction and the second direction is a y-axis direction.

In some embodiments of this application, as shown in FIG. 1 and FIG. 2, FIG. 1 is a schematic structural diagram of an embodiment of an air nozzle according to this application, and FIG. 2 is a schematic structural diagram of an internal structure according to the embodiment shown in FIG. 1. This application provides an air nozzle, including an air outlet chamber 1, an air return chamber 2, and an infrared light assembly 3. The air outlet chamber 1 includes an air outlet panel 11, the air outlet panel 11 facing a substrate to be treated; the air return chamber 2 is provided with an air return panel 21 on a surface facing the substrate; the air outlet panel 11 is configured to convey a medium in the air outlet chamber 1 to outside the air nozzle, and the medium enters the air return chamber 2 through the air return panel 21 after passing through the substrate; and the infrared light assembly 3 is provided on a path of the medium entering the air return chamber 2.

The air nozzle may be a device integrally formed with a housing and having the foregoing structure inside. The inside of the air nozzle is separated by a partition into the air return chamber 2 and the air outlet chamber 1 that are arranged adjacent to each other in a first direction. The infrared light assembly 3 is provided at an opening of the air return chamber 2. Specifically, the air return chamber 2 in the housing is located in the middle of the housing, on both sides are the air outlet chamber 1 formed through separation using a partition, and the air outlet chambers 1 on the two sides communicate with each other. Without limitation, the air nozzle may alternatively be an air return apparatus and an air outlet apparatus that are adjacent to each other, the air return chamber 2 is provided in the air return apparatus, the air outlet chamber 1 is provided in the air outlet apparatus, and the infrared light assembly 3 is provided at an air return opening of the air return apparatus.

Referring to FIG. 1, a plurality of punch holes 22 for communication with the air return chamber 2 may be provided on the air return panel 21. Specifically, the medium may be a gas for drying, such as air. Specifically, the plurality of punch holes 22 are provided in an array on the air return panel 21. The air nozzle may further be provided with a mounting strip 4, where the mounting strip 4 is configured to fasten the air nozzle to an air duct piping within the coater. Without limitation, two mounting strips 4 may be provided and the mounting strips 4 are provided on the air return panel 21. Specifically, the mounting strip 4 may be provided with a plurality of through holes for fastening. Without limitation, the infrared light assembly 3 includes an infrared light and a fastener, and the fastener is used to fasten the infrared light to the air nozzle housing. Without limitation, the housing may be of various shapes and sizes, such as a rectangular shape, a cylindrical shape, and a hexagonal prism shape. Specifically, the shape of the housing may be determined based on specific shapes and sizes of mounting positions in the coater. The housing may be made of various materials, such as iron, aluminum, stainless steel, aluminum alloy, and plastic, which are not particularly limited in the embodiments of this application.

The mounting position of the infrared light assembly 3 is set on a path of a first medium entering the air return panel 21, allowing the medium used in large amount for drying to be effectively utilized. When the medium passes through the infrared light assembly 3, a large amount of heat is removed from the infrared light assembly 3 through conduction heat dissipation and convection heat dissipation. This not only implements rapid cooling of the infrared light assembly 3, but also implements secondary utilization of the medium to effectively replace the use of an emitter cooler, significantly cutting the installation costs for using an infrared drying system.

In some embodiments of this application, as shown in FIG. 1 and FIG. 4, FIG. 1 is a schematic structural diagram of an embodiment of an air nozzle according to this application, and FIG. 4 is a schematic structural diagram of another embodiment of an air nozzle according to this application. The air outlet chamber 1 and the air return chamber 2 are spaced apart in the first direction.

Inside the housing, the air outlet chamber 1 and the air return chamber 2 are provided adjacent to each other and spaced apart, separated from each other by a partition integrally formed with the housing. Without limitation, the air outlet chamber 1 and the air return chamber 2 may be respectively provided in two separate housings.

The air outlet chamber 1 and the air return chamber 2 being spaced apart can effectively integrate the space occupied by the air outlet chamber and the air return chamber, optimizing an internal structure of the air nozzle.

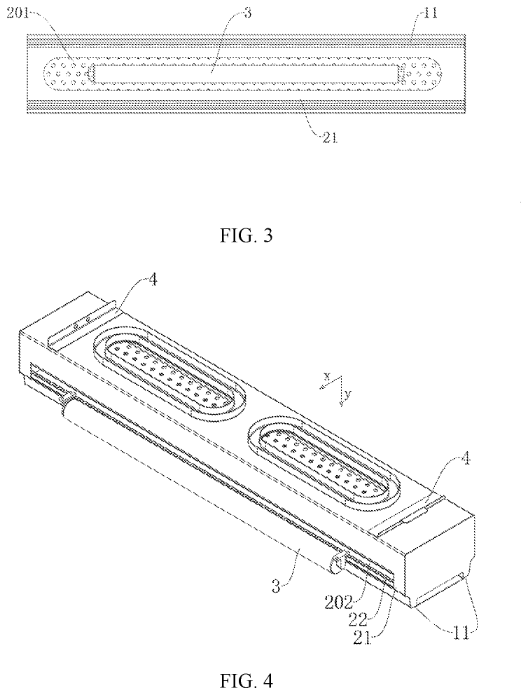

In some embodiments of this application, as shown in FIG. 1, FIG. 2 and FIG. 3, FIG. 1 is a schematic structural diagram of an embodiment of an air nozzle according to this application, FIG. 2 is a schematic structural diagram of an internal structure according to the embodiment shown in FIG. 1, and FIG. 3 is a schematic structural diagram of an air outlet panel 11 according to the embodiment shown in FIG. 1. The air outlet panel 11 is formed by two opposite air outlet side panels 111 that are bent to respective opposite sides, where a gap is present between the two air outlet side panels 111, and the air return panel 21 is provided within the gap.

A gap is provided between the air return panel 21 and the air outlet side panels 111 on two sides, and the gap communicates with the air outlet chamber 1 for conveying a medium outward from the air outlet chamber 1. Without limitation, the air outlet side panel 111 may be provided with through holes for conveying the medium. Specifically, the air outlet panel 11 is flush with the air return panel 21. Specifically, the two air outlet side panels 111 flush with each other after being bent.

Such structure of the air outlet side panels 111 allows the air outlet chamber 1 and the air return chamber 2 to be spaced apart, optimizing the internal mechanical structure of the air nozzle.

In some embodiments of this application, as shown in FIG. 1 and FIG. 2, FIG. 1 is a schematic structural diagram of an embodiment of an air nozzle according to this application, and FIG. 2 is a schematic structural diagram of an internal structure according to the embodiment shown in FIG. 1. The air return panel 21 is provided with a sink groove 201 sunk in a second direction, the infrared light assembly 3 is provided on a bottom wall of the sink groove 201, and punch holes 22 are provided in the bottom wall of the sink groove 201, where the bottom wall of the sink groove 201 faces a substrate.

The air return panel 21 and the sink groove 201 may be provided independently of each other, and panels in which the air return panel 21 and the sink groove 201 are located are two layers of panels stacked in the second direction, the infrared light assembly 3 is provided on the lower panel, and through holes are provided on the upper panel in an irradiation path of the infrared light assembly 3 to avoid blocking the infrared light assembly 3.

When the infrared light assembly 3 is provided on the bottom wall of the sink groove 201, in practice, the medium throughput at the infrared light assembly 3 can reach 200-5000 m³/h.

Arrangement of the sink groove 201 makes the infrared light assembly 3 be mounted at the end of a path of the medium entering the air return chamber 2, effectively fitting an air return path of the medium. The air return volume at this place is huge, facilitating cooling of the infrared light assembly 3.

In some embodiments of this application, as shown in FIG. 4, FIG. 4 is a schematic structural diagram of another embodiment of an air nozzle according to this application. The air outlet panel 11 is provided at one end of the air nozzle, the air return panel 21 is provided around the air outlet panel 11, and the infrared light assembly 3 is provided on the air return panel 21.

The air return panel 21 being provided on one side of the air nozzle allows the air outlet chamber 1 and the air return chamber 2 to be spaced apart.

In some embodiments of this application, as shown in FIG. 4, FIG. 4 is a schematic structural diagram of another embodiment of an air nozzle according to this application. The air return panel 21 is provided with a side groove 202 sunk in the first direction, punch holes 22 are provided in a bottom wall of the side groove 202, and the infrared light assembly 3 is provided on an opening of the side groove 202, close to one side of the air outlet panel 11.

Referring to FIG. 4, without limitation, the punch holes 22 are provided in a side wall of the side groove 202. Specifically, the infrared light assembly 3 may be fastened to a lower edge of the side groove 202 by bolts.

When the infrared light assembly 3 is provided at the lower edge of the side groove 202, in practice, the medium throughput at the infrared light assembly 3 can reach 200-5000 m³/h.

The infrared light assembly 3 is provided on the opening of the side groove 202, close to one side of the air outlet panel 11, so that the medium needs to pass through the infrared light assembly 3 after entering the air return chamber 2 path. This effectively extends a contact time between the medium and the infrared light assembly 3 and improves the cooling effect of the medium on the infrared light assembly 3. Moreover, the foregoing structure also enables the infrared light assembly 3 to be provided on the outside of the air nozzle, separate from the air nozzle, which reduces obstruction that blocks the infrared light assembly 3 from irradiating the substrate, thus improving the irradiation effect of the infrared light assembly 3.

In some embodiments of this application, in a preferred embodiment of this application, as shown in FIG. 5, FIG. 5 is a schematic structural diagram of still another embodiment of an air nozzle according to this application. The air outlet chamber 1 and the air return chamber 2 are spaced apart in a first direction.

A housing is composed of two sub-housings provided adjacent to each other, and the air outlet chamber 1 and the air return chamber 2 are provided in the two sub-housings respectively.

The air outlet chamber 1 and the air return chamber 2 being spaced apart can prevent media in the air outlet chamber 1 and the air return chamber 2 from affecting each other due to close proximity of the two chambers.

In some embodiments of this application, as shown in FIG. 5, FIG. 5 is a schematic structural diagram of still another embodiment of an air nozzle according to this application. A mounting groove 203 sunk in a second direction is formed on a side of the air return chamber 2 close to the air outlet chamber 1, a bottom wall of the mounting groove 203 facing the substrate; the infrared light assembly 3 is provided on the bottom wall of the mounting groove 203; and the air return panel 21 is provided in the mounting groove 203, on a side away from the air outlet chamber 1.

A sub-housing of the air return chamber 2 and a sub-housing of the air outlet chamber 1 are disposed in parallel, and may be connected by welding, bolting, snap-fitting, or the like. Specifically, side walls of the mounting groove 203 are disposed obliquely. Without limitation, the bottom of the infrared light assembly 3 is connected to the bottom wall of the mounting groove 203.

When the infrared light assembly 3 is provided on the bottom wall of the mounting groove 203, in practice, the medium throughput at the infrared light assembly 3 can reach 200-5000 m³/h.

Arrangement of the mounting groove 203 makes the medium pass through the infrared light assembly 3 after entering the air return chamber 2 path, ensuring the cooling effect of the medium on the infrared light assembly 3. Moreover, the arrangement of the mounting groove 203 also reduces obstruction that blocks the infrared light assembly 3 from irradiating the substrate, thus improving the irradiation effect of the infrared light assembly 3.

According to a second aspect of the embodiments of this application, a coater is provided, including the foregoing air nozzle, where an air drying duct in the coater communicates with the air outlet chamber 1 on the air nozzle, and an air return duct in the coater communicates with the air return chamber 2 on the air nozzle.

With the foregoing air nozzle structure, the coater can effectively satisfy drying requirements.

Compared with the prior art, in the air nozzle of the embodiments of this application, the mounting position of the infrared light assembly 3 is set on a path of a first medium entering the air return panel 21, allowing the medium used in large amount for drying to be effectively utilized. When the medium passes through the infrared light assembly 3, a large amount of heat is removed from the infrared light assembly 3 through conduction heat dissipation and convection heat dissipation. This not only implements rapid cooling of the infrared light assembly 3, but also implements secondary utilization of the medium to effectively replace the use of an emitter cooler, significantly cutting the installation costs for using an infrared drying system.

In conclusion, it should be noted that the above examples are merely intended for describing the technical solutions of this application but not for limiting this application. Although this application is described in detail with reference to the foregoing examples, persons of ordinary skill in the art should understand that they may still make modifications to the technical solutions described in the foregoing examples or make equivalent replacements to some or all technical features thereof without departing from the scope of the technical solutions of the examples of this application. They should all be covered in the scope of claims and summary in this application. In particular, as long as there is no structural conflict, the various technical features mentioned in the embodiments can be combined in any manners. This application is not limited to the specific embodiments disclosed in this specification, but includes all technical solutions falling within the scope of the claims.

1. An air nozzle, comprising an air outlet chamber, an air return chamber and an infrared light assembly, wherein the air outlet chamber comprises an air outlet panel, the air outlet panel facing a substrate to be treated; the air return chamber is provided with an air return panel on a surface facing the substrate; the air outlet panel is configured to convey a medium in the air outlet chamber to outside the air nozzle, and the medium enters the air return chamber through the air return panel after passing through the substrate; and the infrared light assembly is provided on a path of the medium entering the air return chamber.

2. The air nozzle according to claim 1, wherein the air outlet chamber and the air return chamber are spaced apart in a first direction.

3. The air nozzle according to claim 1, wherein the air outlet panel is formed by two opposite air outlet side panels that are bent to respective opposite sides, a gap is present between the two air outlet side panels, and the air return panel is provided within the gap.

4. The air nozzle according to claim 1, wherein the air return panel is provided with a sink groove sunk in a second direction, and the infrared light assembly is provided on a bottom wall of the sink groove.

5. The air nozzle according to claim 4, wherein the bottom wall of the sink groove faces the substrate.

6. The air nozzle according to claim 1, wherein the air outlet panel is provided at one end of the air nozzle, the air return panel is provided around the air outlet panel, and the infrared light assembly is provided on the air return panel.

7. The air nozzle according to claim 1, wherein the air return panel is provided with a side groove sunk in the first direction, and the infrared light assembly is provided on an opening of the side groove, close to one side of the air outlet panel.

8. The air nozzle according to claim 1, wherein the air outlet chamber and the air return chamber are spaced apart in the first direction.

9. The air nozzle according to claim 1, wherein a mounting groove sunk in the second direction is formed on a side of the air return chamber close to the air outlet chamber, a bottom wall of the mounting groove facing the substrate; the infrared light assembly is provided on the bottom wall of the mounting groove; and the air return panel is provided in the mounting groove, on a side away from the air outlet chamber.

10. A coater, comprising the air nozzle according to claim 1, wherein an air drying duct in the coater communicates with the air outlet chamber on the air nozzle, and an air return duct in the coater communicates with the air return chamber on the air nozzle.
